(19) United States
(12) Patent Application Publication
(10) Pub. No.: US 2023/0277277 A1
(43) Pub. Date: Sep. 7, 2023

(54) Baby Tooth Extraction Tool

(71) Applicants: Reza Zamanian, Plano, TX (US); Rick Townsley, Argyle, TX (US)

(72) Inventors: Reza Zamanian, Plano, TX (US); Rick Townsley, Argyle, TX (US)

(21) Appl. No.: 18/116,789

(22) Filed: Mar. 2, 2023

Related U.S. Application Data
(60) Provisional application No. 63/316,385, filed on Mar. 3, 2022.
(60) Provisional application No. 63/322,127, filed on Mar. 21, 2022.

(51) Int. Cl. A61C 3/14

(52) U.S. Cl. CPC A61C 3/14

(57) ABSTRACT

A tooth extraction tool includes first and second arms each having a contoured distal end and a proximal end, the first and second arms being rotatably joined at a hinged point, a biasing member coupled to the hinged point operable to pressure the contoured distal ends of the arms together to grip a tooth, the proximal ends of the arms being contoured to receive portions of a user's hand to cause the contoured distal ends of the arms to come apart in response to pressing the proximal ends together, and side envelopes coupled to distal portions of the arm to form a tooth retaining pocket.

### CROSS REFERENCE TO RELATED APPLICATION

This application claims the benefit of U.S. Provisional Patent Application No. 63/316,385, filed on Mar. 3, 2022, and U.S. Provisional Patent Application No. 63/322,127, filed on Mar. 21, 2022, both of which are incorporated herein by reference in their entireties.

### FIELD

The present disclosure relates to a dental tool, and in particular, to a baby tooth extraction tool for home-use.

### BACKGROUND

Most children begin to lose their baby teeth at around age 6. As an adult tooth grows, it pushes out and loosens the baby tooth above it. Most of the time, baby teeth gradually loosen and fall out naturally. However, there are instances when some assistance from an adult is welcomed. Many resort to schemes such as tying one end of a string around the tooth with the other end tied to a doorknob, where slamming the door causes the tooth to be pulled out of the socket. Others resort to a trip to the family dentist's office for professional help.

### BRIEF DESCRIPTION OF THE DRAWINGS

FIG. 1 is a side view of a first embodiment of a disposable baby tooth extraction tool for home use according to the teachings of the present disclosure;

FIG. 2 is a side view of a second embodiment of a disposable baby tooth extraction tool for home use according to the teachings of the present disclosure;

FIG. 3 is a side view of a third embodiment of a disposable baby tooth extraction tool for home use according to the teachings of the present disclosure;

FIGS. 4A and 4B are side views of a fourth embodiment of a disposable baby tooth extraction tool for home use according to the teachings of the present disclosure; and

FIGS. 5-7 are illustrations of existing conventional dental forceps currently in use by dentists in dental clinics.

### DETAILED DESCRIPTION

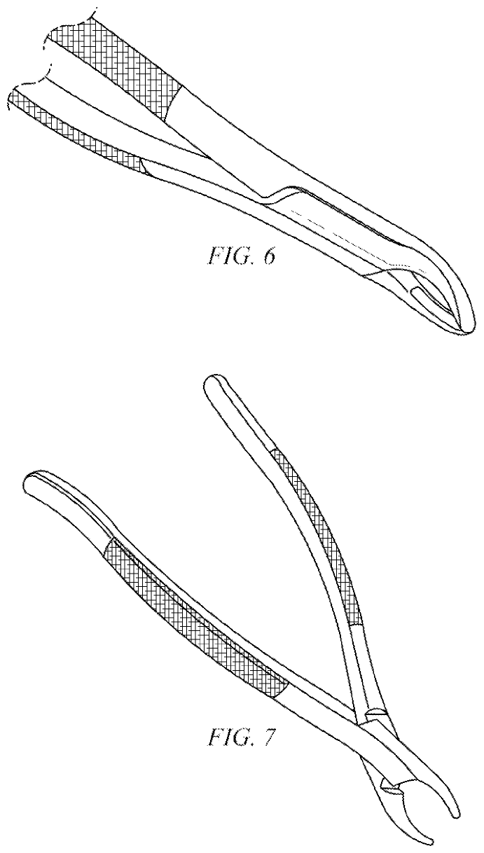

The tool described herein is designed for use by parents to more easily remove their children's baby teeth at home. The tooth extraction tool described herein is easy to use as compared to existing conventional dental forceps currently in use by dentists in dental clinics as shown in FIGS. 5-7.

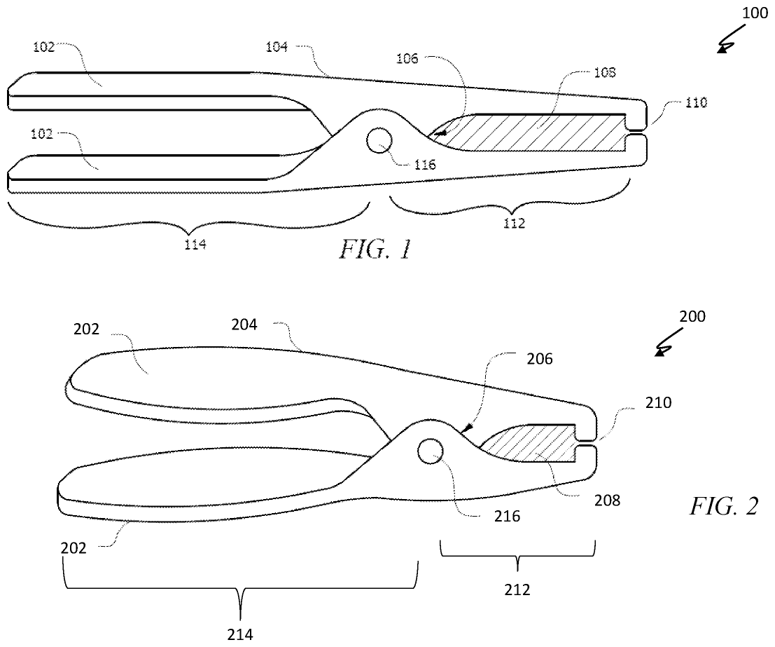

FIG. 1 is a side view of a first embodiment of a disposable baby tooth extraction tool 100 for home use according to the teachings of the present disclosure. The tool 100 has two cooperating arms 104 that are rotatably joined at a hinged point 116 near the center of the tool. The rotatable joint 116 of the two arms 104 is preferably biased by a coiled spring 106 or another type of biasing member (not explicitly shown). At the distal end of each arm 104 is a contoured tip 110 forming a pair of jaws designed to grip the base or root of a tooth to be extracted. The contoured tips 110 may have a shape and texture that facilitate a firm grip of the tooth. The contoured tips or jaws 110 preferably curve toward one another and come to rest together as biased by the coiled spring 106. The tool 100 further includes a flexible or elastic side envelope 108 joining the distal portions of the arms 104 on both sides to form a tooth retaining pocket with its opening formed by the tips 110. The proximal portion 114 of the arms 104 may have contoured surfaces designed to comfortably receive the user's fingertips or other parts of the hand. The distal portion 112 and proximal portion 114 of the arms 104 are preferably in linear alignment, with the distal portion 112 being shorter in length than the proximal portion 114.

In operation, the user may hold the tool 100 using the thumb and index finger on the finger pads 102 of the tool. At rest without any pressure exerted on the finger pads 102, the distal tips 110 of the tool are biased by the spring 106 to be in the closed configuration. Due to the action of the user's fingers on the finger pads 102 pinching together to supply sufficient pressure to overcome the biasing force of the spring 106, the distal tips or jaws 110 of the arms 104 come apart. The user may then position the distal tips of the tool around the base of the tooth and release the finger pressure. This allows the distal tips of the tool to come back together and grip the base of the tooth. The user may then use the tool to dislodge and extract the tooth. When the tooth is successfully extracted, it is caught and retained within the pocket formed by the distal portions 112 of the arms and the side envelopes 108.

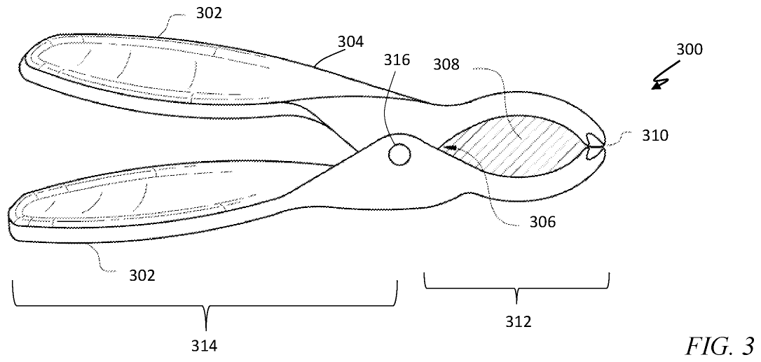

FIG. 2 is a side view of a second embodiment of a disposable baby tooth extraction tool 200 for home use according to the teachings of the present disclosure. The tool 200 has two cooperating arms 204 that are rotatably joined at a hinged point 216 near the center of the tool 200. The rotatable joint 216 of the two arms 204 is preferably biased by a coiled spring 206 or another type of biasing member (not explicitly shown). At the distal end of each arm 204 is a contoured tip 210 forming a pair of jaws designed to grip the base of a tooth to be extracted. The contoured tips 210 may have a shape and texture that facilitate a firm grip of the tooth. The contoured tips or jaws 210 preferably curve toward one another and come to rest together as biased by the coiled spring 206. The tool 200 further includes a flexible or elastic side envelope 208 joining the distal portions of the arms 204 on both sides to form a tooth retaining pocket with its opening formed by the tips 210. The proximal portion 214 of the arms 204 have enlarged or broadened contoured finger pads or handles 202 designed to receive the user's fingertips or other parts of the hand. The distal portion 212 and proximal portion 214 of the arms 204 are preferably in linear alignment, with the distal portion 212 being shorter in length than the proximal portion 214.

In operation, the user may hold the tool 200 using the thumb and index finger on the finger pads 202 of the tool. Alternatively, because the broader configuration of the handles 202, they are sized for handling and operation by the entire hand of the user, where the user's palm and the fingers cooperate to apply pressure on the proximal portions of the arms 204. At rest without any pressure exerted on the handles 202, the distal tips 210 of the tool 200 are biased by the spring 206 to be in the closed configuration. Due to the action of the user's fingers on the finger pads or handles 202 pinching together to supply sufficient pressure to overcome the biasing force of the spring 206, the distal tips or jaws 210 of the arms 204 come apart. The user may then position the distal tips of the tool around the base of the tooth and release the finger pressure. This allows the distal tips of the tool to come back together and grip the base of the tooth. The user may then use the tool to dislodge and extract the tooth. When the tooth is successfully extracted, it is caught and retained within the pocket formed by the distal portions 212 of the arms and the side envelopes 208.

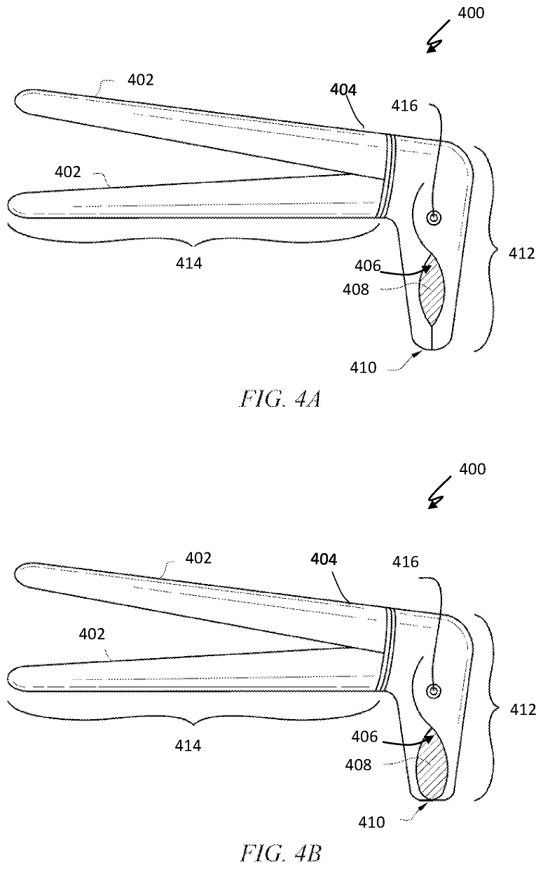

FIG. 3 is a side view of a third embodiment of a disposable baby tooth extraction tool 300 for home use according to the teachings of the present disclosure. The tool 300 has two cooperating arms 304 that are rotatably joined at a hinged point 316 near the center of the tool 200. The rotatable joint 316 of the two arms 304 is preferably biased by a coiled spring 306 or another type of biasing member (not explicitly shown). At the distal end of each arm 304 is a contoured tip 310 forming a pair of jaws designed to grip the base of a tooth to be extracted. The contoured tips 310 may have a shape and texture that facilitate a firm grip of the tooth. The distal portion 312 of the arm 304 preferably include a curvature toward each other terminating in contoured jaws 310 that come to rest together as biased by the coiled spring 306. The tool 300 further includes a flexible or elastic side envelope 308 joining the distal portions of the arms 304 on both sides to form a tooth retaining pocket with its opening formed by the distal tips 310. The proximal portion 314 of the arms 304 have enlarged contoured finger pads or handles 302 designed to comfortably receive the user's fingertips or other parts of the hand. The distal portion 312 and proximal portion 314 of the arms 304 are preferably in linear alignment, with the distal portion 312 being shorter in length than the proximal portion 314.

In operation, the user may hold the tool 300 using the thumb and index finger on the finger pads 302 of the tool. Alternatively, because the broader configuration of the handles 302, they are sized for handling and operation by the entire hand of the user, where the user's palm and the fingers cooperate to apply pressure on the proximal portions of the arms 304. At rest without any pressure exerted on the handles 302, the distal tips 310 of the tool 300 are biased by the spring 306 to be in the closed configuration. Due to the action of the user's fingers on the finger pads or handles 302 pinching together to supply sufficient pressure to overcome the biasing force of the spring 306, the distal tips or jaws 310 of the arms 304 come apart. The user may then position the distal tips of the tool around the base of the tooth and release the finger pressure. This allows the distal tips of the tool to come back together and grip the base of the tooth. The user may then use the tool to dislodge and extract the tooth. When the tooth is successfully extracted, it is caught and retained within the pocket formed by the distal portions 312 of the arms and the side envelopes 308.

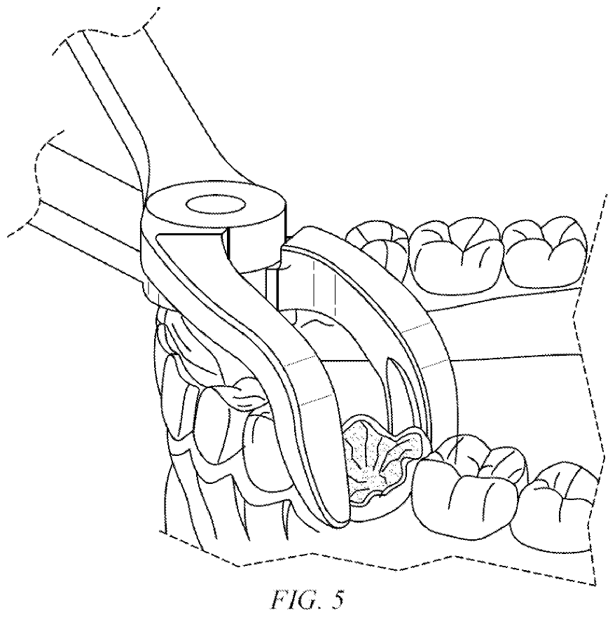

FIGS. 4A and 4B are side views of a fourth embodiment of a disposable baby tooth extraction tool 400 for home use according to the teachings of the present disclosure. The tool 400 has two cooperating arms 404 that are rotatably joined at a hinged point 416 near the center of the tool 400. The rotatable joint 416 of the two arms 404 is preferably biased by a coiled spring 406 or another type of biasing member (not explicitly shown). At the distal end of each arm 404 is a contoured tip 410 forming a pair of jaws designed to grip the base of a tooth to be extracted. The contoured tips 410 may have a shape and texture that facilitate a firm grip of the tooth. The distal portion 412 of the arm 404 preferably curve toward each other terminating in contoured tips or jaws 410 that come to rest together as biased by the coiled spring 406. The tool 400 further includes a flexible or elastic side envelope 408 joining the distal portions of the arms 404 on both sides to form a tooth retaining pocket with its opening formed by the distal tips 410. The proximal portion 414 of the arms 404 have enlarged contoured finger pads or handles 402 designed to receive the user's fingertips or other parts of the hand. It may be seen that this embodiment of the tool has a distal portion 412 of the arms 404 that is configured at an angle with respect to the proximal portion 414 of the arms 404. The angular relationship between the distal portion 412 and proximal portion 414 of the arms 404 may be approximately 90-160 degrees.

In operation, the user may hold the tool 400 using the fingers and palm on the handles 402, where the user's palm and the fingers cooperate to apply pressure on the proximal portions of the arms 404. At rest without any pressure exerted on the handles 402, the distal tips 410 of the tool 400 are biased by the spring 406 to be in the closed configuration. Due to the action of the user's fingers on the finger pads or handles 402 pinching together to supply sufficient pressure to overcome the biasing force of the spring 406, the distal tips or jaws 410 of the arms 404 come apart. The user may then position the distal tips of the tool around the base of the tooth and release the finger pressure. This allows the distal tips of the tool to come back together and grip the base of the tooth. The user may then use the tool to dislodge and extract the tooth. When the tooth is successfully extracted, it is caught and retained within the pocket formed by the distal portions 412 of the arms and the side envelopes 408.

In the preferred embodiments of the baby tooth extraction tool described herein, the arms of the tool are constructed of a sufficiently rigid plastic that would enable the arms to retain their shape when the user is operating the tool. Other suitable materials such as wood, bamboo, metal, etc. may be used to fabricate the tool. The side envelope that forms the tooth retaining pocket may be made of a transparent plastic film to provide a clear view of the extracted tooth. The tool can be manufactured inexpensively so that it may be a single-use device and disposable.

It should be noted that the two arms of the tooth extraction tool may be arranged one of two ways: (1) user actuation causes the tips/jaws to come apart and lack of user actuation causes the jaws to come together; and (2) user actuation causes the tips/jaws to come together and lack of user actuation causes the jaws to come apart.

The features of the present invention which are believed to be novel are set forth below with particularity in the appended claims. However, modifications, variations, and changes to the exemplary embodiments described above will be apparent to those skilled in the art, and the disposable baby tooth extraction tool described herein thus encompasses such modifications, variations, and changes and are not limited to the specific embodiments described herein.

What is claimed is:

1. A tooth extraction tool comprising:
first and second arms being rotatably joined at a hinged point, each arm having a contoured distal end and a proximal end, the contoured distal ends forming a pair of jaws;
the proximal ends of the arms being contoured to receive portions of a user's hand; and
side envelopes coupled to distal portions of the arm to form a tooth retaining pocket.

2. The tooth extraction tool of claim 1, wherein the side envelopes are fabricated from a transparent film material.

3. The tooth extraction tool of claim 1, wherein the first and second arms are made of a material selected from the group consisting of plastic, wood, bamboo, and metal.

4. The tooth extraction tool of claim 1, further comprising a biasing member coupled to the hinged point of the first and second arms.

5. The tooth extraction tool of claim 1, wherein the distal end and the proximal end of each arm are in linear alignment.

6. The tooth extraction tool of claim 1, wherein the distal end and the proximal end of each arm are at an angle of approximately 90°.

7. The tooth extraction tool of claim 1, wherein the proximal ends of the arms are configured to have enlarged pads to comfortably receive the user's fingers.

8. The tooth extraction tool of claim 1, wherein the proximal ends of the arms are configured to have contoured handles to comfortably receive the user's hand.

9. The tooth extraction tool of claim 1, wherein the side envelope is fabricated from a flexible material.

10. The tooth extraction tool of claim 1, wherein the jaws include contoured textured tips configured to grip a base of a tooth.

11. The tooth extraction tool of claim 1, further comprising a biasing member coupled to the hinged point operable to pressure jaws together.

12. The tooth extraction tool of claim 1, further comprising a biasing member coupled to the hinged point operable to pressure the jaws apart.

13. A disposable tooth extraction tool designed for home-use, the tool comprising:
first and second arms being rotatably joined at a hinged point, each arm having a contoured distal end and a proximal end, the contoured distal ends forming a pair of jaws;
a biasing member coupled to the hinged point operable to pressure the jaws in one of coming together and coming apart;
the proximal ends of the arms being contoured to receive portions of a user's hand to exert pressure against the biasing member; and
a tooth retaining pocket formed about the jaws configured to catch and contain an extracted tooth.

14. The tooth extraction tool of claim 13, wherein the tooth retaining pocket is fabricated from a transparent film material.

15. The tooth extraction tool of claim 13, wherein the tooth retaining pocket is fabricated from an elastic material.

16. The tooth extraction tool of claim 13, wherein the first and second arms are made of a material selected from the group consisting of plastic, wood, bamboo, and metal.

17. The tooth extraction tool of claim 13, wherein the distal end and the proximal end of each arm are in linear alignment.

18. The tooth extraction tool of claim 13, wherein the distal end and the proximal end of each arm are at an angle of about 90-160 degrees.

19. A disposable tooth extraction tool comprising:
first and second arms being rotatably joined at a hinged point, each arm having a contoured distal end and a proximal end, the contoured distal ends forming a pair of jaws;
a biasing member coupled to the hinged point operable to pressure the jaws in one of coming together and coming apart;
the proximal ends of the arms being contoured to receive portions of a user's hand to exert pressure against the biasing member; and
a transparent flexible film coupled to the jaws forming a pocket configured to catch and contain an extracted tooth.

20. The tooth extraction tool of claim 19, wherein the first and second arms are made of a material selected from the group consisting of plastic, wood, bamboo, and metal.
